(19) United States
(12) Patent Application Publication
(10) Pub. No.: US 2011/0031771 A1
(43) Pub. Date: Feb. 10, 2011

(54) STORAGE TRUNK IN THE FRONT OF A VEHICLE

(76) Inventor: Yi Ding, San Jose, CA (US)

Correspondence Address: MORRIS MANNING MARTIN LLP, 3343 PEACHTREE ROAD, NE, 1600 ATLANTA FINANCIAL CENTER, ATLANTA, GA, 30326, US

(21) Appl. No.: 12/840,666

(22) Filed: Jul. 21, 2010

Related U.S. Application Data
(60) Provisional application No. 61/232,760, filed on Aug. 10, 2009.

(51) Int. Cl. B62D 25/12; B60R 5/02

(52) U.S. Cl. 296/24.4; 296/76

(57) ABSTRACT

A storage trunk for a vehicle. In one embodiment, the storage trunk comprises a floor and two side lids, one located at the driver side and the other located at the passenger side of the vehicle, respectively, enclosing a storage space in the front of the vehicle. Each of the two side lids is attached to a frame via a pivoting mechanism adapted for allowing said side lid to rotate about the pivoting mechanism when said side lid is being opened or closed. The pivoting mechanism is positioned such that the storage trunk can be accessed from either the driver side or the passenger side of the vehicle when one or both side lids are open.

### CROSS-REFERENCE TO RELATED PATENT APPLICATION

This application claims the benefit, pursuant to 35 U.S.C. §119(e), of U.S. provisional patent application Ser. No. 61/232,760, filed Aug. 10, 2009, entitled “SIDE LIDS AND COMPARTMENT DIVIDERS FOR STORAGE TRUNK IN THE FRONT OF A VEHICLE,” by Yi Ding, which is incorporated herein by reference in its entirety.

### FIELD OF THE INVENTION

The present invention relates generally to a storage trunk for a vehicle, in particular, to a storage trunk in the front of a vehicle.

### BACKGROUND

The majority of automobiles have storage trunks located in the rear of the vehicles. To date, the old VW Beetle might be the only popular auto model with a front trunk. Various reasons including the need for more space for the engine might have contributed to the popularity of rear trunks. With the advent of electrical vehicles, the space needed to host the engine and accessories (including battery packs) is significantly reduced, making it more feasible to place the engine in the rear and the storage trunk in the front. However, the ease of use of a front trunk becomes a concern, as it is inconvenient to access a front trunk with a lid opened from the front of the vehicle similar to the hood over the engine compartment on most vehicles, when the vehicle is parked head-in on a parking slot.

Therefore, a heretofore unaddressed need exists in the art to address the aforementioned deficiencies and inadequacies.

### SUMMARY OF THE INVENTION

In one aspect, the present invention provides a storage trunk for a vehicle. In one embodiment, the storage trunk comprises a floor and two side lids, one located at the driver side and the other located at the passenger side of the vehicle, respectively, enclosing a storage space in the front of the vehicle. Each of the two side lids is attached to a frame via a first pivoting mechanism adapted for allowing said side lid to rotate about the first pivoting mechanism when said side lid is being opened or closed. The first pivoting mechanism is positioned such that the storage trunk can be accessed from either the driver side or the passenger side of the vehicle when one or both side lids are open.

In one embodiment, the first pivoting mechanism for each of the two side lids is positioned at one of the following locations: (i) a front edge of said side lid, (ii) a rear edge of said side lid, and (iii) an inner edge of said side lid longitudinal to the vehicle.

In one embodiment, the storage trunk further comprises a middle lid disposed between the two side lids.

In one embodiment, the middle lid is attached to the frame in one of the following two ways: (i) being fixed to the frame, and (ii) via a second pivoting mechanism adapted for allowing the middle lid to rotate about the second pivoting mechanism when the middle lid is being opened or closed.

In one embodiment, the frame is attached to the storage trunk in one of the following two ways: (i) being fixed to the storage trunk, and (ii) via a third pivoting mechanism adapted for allowing the frame, along with the two side lids and the middle lid, to rotate about the third pivoting mechanism when the frame is being opened or closed.

In another aspect, the present invention provides a storage trunk for a vehicle. In one embodiment, the storage trunk comprises a floor and two side lids, one located at the driver side and the other located at the passenger side of the vehicle, respectively, enclosing a storage space in the front of the vehicle.

In one embodiment, each of the two side lids is attached to a frame via a first pivoting mechanism adapted for allowing said side lid to rotate about the first pivoting mechanism when said side lid is being opened or closed.

In one embodiment, the first pivoting mechanism is positioned such that the storage trunk can be accessed from either the driver side or the passenger side of the vehicle when one or both side lids are open.

In one embodiment, the first pivoting mechanism for each of the two side lids is positioned at one of the following locations: (i) a front edge of said side lid, (ii) a rear edge of said side lid, and (iii) an inner edge of said side lid longitudinal to the vehicle.

In one embodiment, the first pivoting mechanism comprises a hinge.

In one embodiment, the storage trunk further comprises a middle lid disposed between the two side lids.

In one embodiment, the middle lid is attached to the frame in one of the following two ways: (i) being fixed to the frame, and (ii) via a second pivoting mechanism adapted for allowing the middle lid to rotate about the second pivoting mechanism when the middle lid is being opened or closed.

In one embodiment, the second pivoting mechanism comprises a hinge.

In one embodiment, the frame is attached to the storage trunk in one of the following two ways: (i) being fixed to the storage trunk, and (ii) via a third pivoting mechanism adapted for allowing the frame, along with the two side lids and the middle lid, to rotate about the third pivoting mechanism when the frame is being opened or closed.

In one embodiment, the third pivoting mechanism comprises a hinge.

In one embodiment, the storage trunk further comprises a safety interlock mechanism to prevent the vehicle from being driven when any of the following conditions is detected: (i) either or both of the two side lids are not closed, (ii) the middle lid is not closed, and (iii) the frame is not closed.

In one embodiment, edges of the two side lids, edges of the middle lid, and edges of the frame are shaped such that liquid is prevented from entering the storage space.

In one embodiment, the storage trunk further comprises one or more dividers to petition the storage space into two or more sub storage spaces.

In one embodiment, the dividers can be folded when the dividers are not in use, and the folded dividers can be secured to the floor of the storage trunk, or to the underside of the two side lids.

In another embodiment, the dividers are removable and the storage trunk further comprises fasteners for storing the dividers in the storage trunk when the dividers are not in use.

These and other aspects of the present invention will become apparent from the following description of the preferred embodiment taken in conjunction with the following drawings and their captions, although variations and modifications therein may be affected without departing from the spirit and scope of the novel concepts of the disclosure.

### BRIEF DESCRIPTION OF THE DRAWINGS

The drawings described below are for illustration purposes only. The drawings are not intended to limit the scope of the present teachings in any way.

FIG. 1 illustrates a storage trunk in the front of a vehicle according to one embodiment.

FIG. 2 is a partial cross-sectional view illustrating a design of a handle flap for a lid, according to one embodiment.

FIG. 3A is a partial cross-sectional view illustrating a design of the longitudinal inner edge of a side lid and of the edges of a longitudinal beam of a frame, according to one embodiment.

FIG. 3B is a partial cross-sectional view illustrating a design of the longitudinal inner edge of a side lid and of a longitudinal edge of a middle lid, according to one embodiment.

FIG. 4 is a partial cross-sectional view illustrating a design of a trunk divider, according to one embodiment.

### DETAILED DESCRIPTION

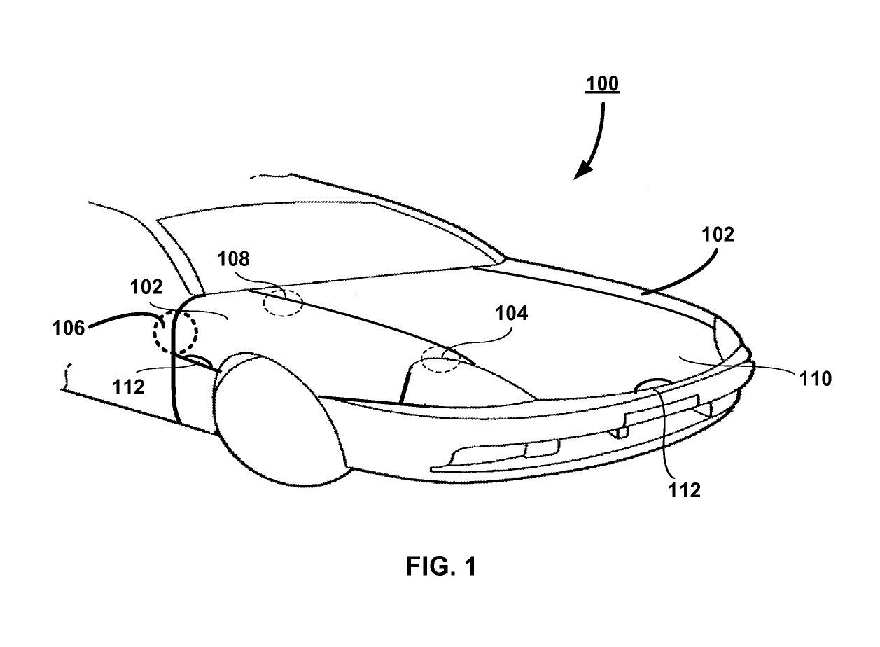

The present invention is more particularly described in the following examples that are intended as illustrative only since numerous modifications and variations therein will be apparent to those skilled in the art. Various embodiments of the invention are now described in detail. Referring to the drawings, FIGS. 1-4, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

FIG. 1 illustrates a storage trunk 100 in the front of a vehicle, according to one embodiment of the present invention. To provide easy access to the storage trunk, the storage trunk comprises two side lids 102, one located at the driver side and the other located at the passenger side of the vehicle, respectively. Each of the two side lids 102 is attached to trunk via a pivoting mechanism, such as a hinge. The pivoting mechanism for each of the two side lids may be positioned at one of the following locations: (i) a front edge 104 of said side lid, (ii) a rear edge 106 of said side lid, and (iii) an inner edge 108 of said side lid longitudinal to the vehicle.

In one embodiment, a middle lid 110, disposed between the two side lids 102, may be provided, especially when the trunk space is sufficiently large. The middle lid 110 is preferably narrower than a conventional hood, making the two side lids 102 wider than a conventional front fender for access to more trunk space from the side. The middle lid 110 may be fixed to the trunk, or alternatively be attached to the trunk via a pivoting mechanism such as a hinge.

It is desirable to have a mechanism to open all the lids as a whole when storing large objects in the trunk. In one embodiment, the two side lids 102 and the optional middle lid 110 are attached to a supporting frame. The supporting frame may be fixed to the trunk, or alternatively be attached to the trunk via a pivoting mechanism such as a hinge. In the later case, the supporting frame, along with the two side lids 102 and the optional middle lid 110, can be opened as a whole, rendering the entire trunk uncovered so that large objects can be loaded into or removed from the trunk.

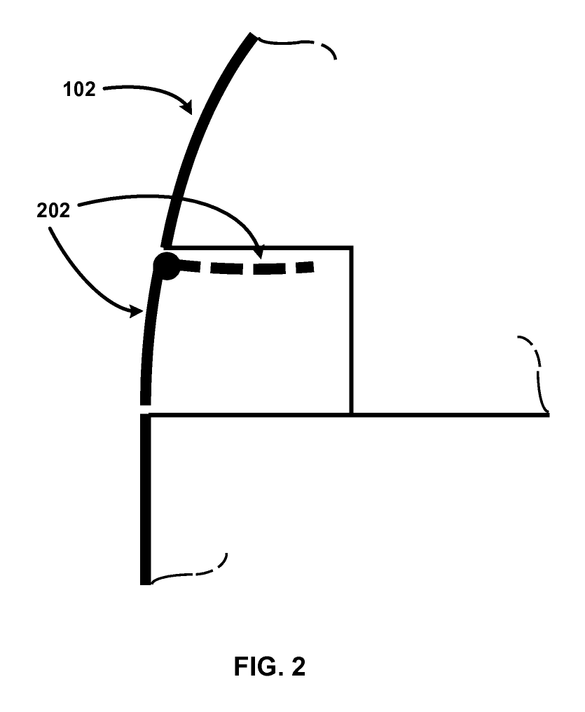

In one embodiment, each of the two side lids 102 and the optional middle lid 110 has a locking-releasing mechanism 112 to secure the lid to the trunk when the lid is closed, and to release the lid when the lid is being opened, respectively. The locking-releasing mechanism can be similar to that of a conventional rear trunk or similar to that of a door of a passenger compartment. Additionally, the mechanism may utilize a handle flap that is actuated when pushed in then pulled up to release the lid, so that the recess behind the flap does not need to be exposed when the flap is in the resting position conforming to the body contour of the vehicle so as to reduce air drag. FIG. 2 illustrates such a handle flap design according to one embodiment. The pushed-in position of the handle flap 202 is represented using the dashed line. An actuation means attached to the handle flap 202 is needed but is not shown in FIG. 2.

The frame may contain longitudinal beam(s) below the inner longitudinal edges of the side lids to provide structural support and/or rainwater diverting pathway. Alternatively, the pivoting mechanism for the side lids may be mounted on the portion of the supporting frame near the windshield. It should be noted that if the space between the strut towers is occupied by air conditioning units and not form part of the trunk, a widened portion of the frame over this space does not impact the utility of the trunk.

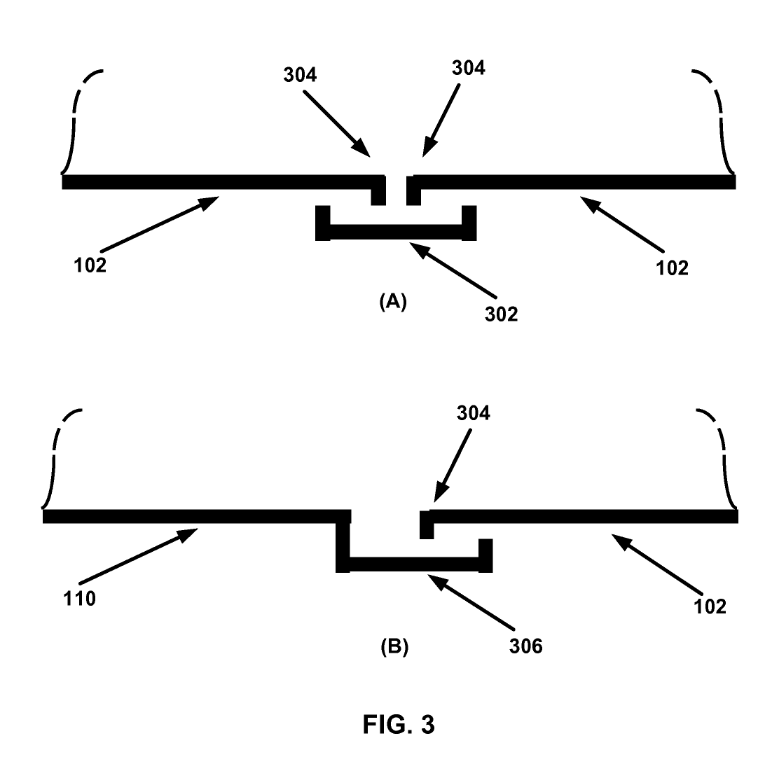

Referring to FIG. 3A, to prevent rainwater or other liquid from entering the trunk through the inner edges 304 of the side lids 102, the longitudinal beam(s) 302 of the supporting frame below the inner edges 304 of the side lids 102 may be shaped with a grove on the upper side running along the length, and the inner edges 304 of the side lids 102 may slightly curl or bend down into the grove. Referring to FIG. 3B, if there is a middle lid 110 between the two side lids 102, the longitudinal edge 306 on a longitudinal side of the middle lid 110 may bend down to form a grove below the inner edge 304 of a side lid 102. Alternatively, the inner edge of each of the two side lids 102 may extend below the middle lid 110 and form a grove if the side lids are hinged along the inner edge. This latter configuration also works if there is a middle lid and the side lids are hinged over an extension of the supporting frame near the windshield. If the trunk has only two side lids without a middle lid and the side lids are hinged along the inner longitudinal edges over a widened portion of the supporting frame near the windshield, the inner edge of one of the two lids may extend below the other to form a grove.

Since the lids and the supporting frame of the storage trunk may be opened and closed frequently, there may be safety risks if they are not properly closed before the vehicle is driven. Therefore, safety interlock mechanism using means to verify proper closure of the trunk such as switches or sensors may be employed to prevent the vehicle from being driven unless all lids and the supporting frame are properly locked.

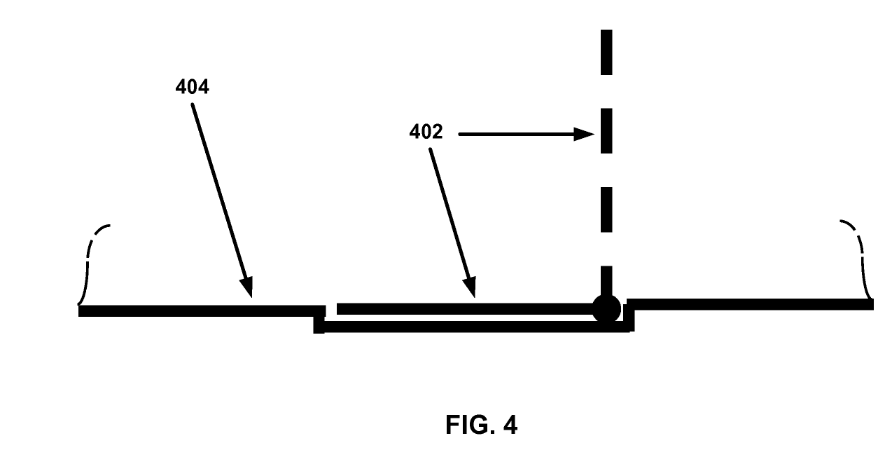

When storing small objects and only using a lid on one side, it is desirable to prevent the objects from moving to the other side of the trunk during transport. Therefore, trunk dividers may be furnished that partition the trunk space into zones corresponding to each lid. FIG. 4 illustrates a divider design according to one embodiment. The divider 402 is erected to a substantially vertical positions (indicated by the dashed line) and secured to such position using a pinning or locking means such as locking bolts, and is folded down into recesses (indicated by the solid line) on the trunk floor 404, preferably making a flat surface on the trunk floor 404 when the divider is not in use. Alternatively, the divider can be hinged on the lids and normally secured on the underside of the lids using a securing means, and folded down when in use. Another embodiment of the dividers is elastic meshes, which are mounted on a few hooks on the inner surface of the trunk when in use, and folded to corners of the trunk or spun on an inner surface of the trunk when not in use.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A storage trunk for a vehicle, comprising:
(a) a floor; and
(b) two side lids, one located at the driver side and the other located at the passenger side of the vehicle, respectively, enclosing a storage space in the front of the vehicle;
wherein each of the two side lids is attached to a frame via a first pivoting mechanism adapted for allowing said side lid to rotate about the first pivoting mechanism when said side lid is being opened or closed; and
wherein the first pivoting mechanism is positioned such that the storage trunk can be accessed from either the driver side or the passenger side of the vehicle when one or both side lids are open.

2. The storage trunk of claim 1, wherein the first pivoting mechanism for each of the two side lids is positioned at one of the following locations:
(i) a front edge of said side lid;
(ii) a rear edge of said side lid; and
(iii) an inner edge of said side lid longitudinal to the vehicle.

3. The storage trunk of claim 1, further comprising a middle lid disposed between the two side lids.

4. The storage trunk of claim 3, wherein the middle lid is attached to the frame in one of the following two ways:
(i) being fixed to the frame; and
(ii) via a second pivoting mechanism adapted for allowing the middle lid to rotate about the second pivoting mechanism when the middle lid is being opened or closed.

5. The storage trunk of claim 3, wherein the frame is attached to the storage trunk in one of the following two ways:
(i) being fixed to the storage trunk; and
(ii) via a third pivoting mechanism adapted for allowing the frame, along with the two side lids and the middle lid, to rotate about the third pivoting mechanism when the frame is being opened or closed.

6. A storage trunk for a vehicle, comprising:
(a) a floor; and
(b) two side lids, one located at the driver side and the other located at the passenger side of the vehicle, respectively, enclosing a storage space in the front of the vehicle.

7. The storage trunk of claim 6, wherein each of the two side lids is attached to a frame via a first pivoting mechanism adapted for allowing said side lid to rotate about the first pivoting mechanism when said side lid is being opened or closed.

8. The storage trunk of claim 7, wherein the first pivoting mechanism is positioned such that the storage trunk can be accessed from either the driver side or the passenger side of the vehicle when one or both side lids are open.

9. The storage trunk of claim 8, wherein the first pivoting mechanism is positioned at one of the following locations:
(i) a front edge of said side lid;
(ii) a rear edge of said side lid; and
(iii) an inner edge of said side lid longitudinal to the vehicle.

10. The storage trunk of claim 7, wherein the first pivoting mechanism comprises a hinge.

11. The storage trunk of claim 7, further comprising a middle lid disposed between the two side lids.

12. The storage trunk of claim 11, wherein the middle lid is attached to the frame in one of the following two ways:
(i) being fixed to the frame; and
(ii) via a second pivoting mechanism adapted for allowing the middle lid to rotate about the second pivoting mechanism when being opened or closed.

13. The storage trunk of claim 12, wherein the second pivoting mechanism comprises a hinge.

14. The storage trunk of claim 11, wherein the frame is attached to the storage trunk in one the following two ways:
(i) being fixed to the storage trunk; and
(ii) via a third pivoting mechanism adapted for allowing the frame, along with the two side lids and the middle lid, to rotate about the third pivoting mechanism when the frame is being opened or closed.

15. The storage trunk of claim 14, wherein the third pivoting mechanism comprises a hinge.

16. The storage trunk of claim 14, further comprising a safety interlock mechanism to prevent the vehicle from being driven when any of the following conditions is detected:
(i) either or both of the two side lids are not closed;
(ii) the middle lid is not closed; and
(iii) the frame is not closed.

17. The storage trunk of claim 11, wherein edges of the two side lids, edges of the middle lid, and edges of the frame are shaped such that liquid is prevented from entering the storage space.

18. The storage trunk of claim 6, further comprising one or more dividers to petition the storage space into two or more sub storage spaces.

19. The storage trunk of claim 18, wherein the dividers can be folded when the dividers are not in use, and wherein the folded dividers can be secured to the floor of the storage trunk, or to the underside of the two side lids.

20. The storage trunk of claim 18, wherein the dividers are removable and the storage trunk further comprises fasteners for storing the dividers in the storage trunk when the dividers are not in use.
